(19) United States
(12) Patent Application Publication
(10) Pub. No.: US 2021/0265078 A1
(43) Pub. Date: Aug. 26, 2021

(54) CABLE

(71) Applicant: Yazaki Corporation, Tokyo (JP)

(72) Inventor: Hiroki GOTO, Shizuoka (JP)

(73) Assignee: Yazaki Corporation, Tokyo (JP)

(21) Appl. No.: 17/183,588

(22) Filed: Feb. 24, 2021

(30) Foreign Application Priority Data
Feb. 26, 2020 (JP) 2020-030170

(51) Int. Cl. H01B 7/00; H01R 11/12; H02G 5/00

(52) U.S. Cl. CPC H01B 7/0045; H01B 7/18; H02G 5/007; H01R 11/12

(57) ABSTRACT

The cable includes a plurality of first cables provided in parallel each having a core wire made of conductive metal and an insulation sheath covering the outer circumference of the core wire, and the core wires exposed from the respective insulation sheaths of the plurality of first cables are connected to the bus bar. The bus bar has a bolt insertion hole. Further, each first cable has an allowable voltage of less than 12 V.

### CROSS-REFERENCE TO RELATED APPLICATIONS

The present application is based on, and claims priority from Japanese Patent Application No. 2020-030170, filed on Feb. 26, 2020, the entire contents of which are incorporated herein by reference.

### TECHNICAL FIELD

The present application relates to a subdivided cable.

### BACKGROUND

JP 2012-243550 A includes a high-voltage cable in which a plurality of aligned conductors (core wires) are collectively sheathed with an insulator.

### SUMMARY

However, in the high-voltage cable of JP 2012-243550 A, since the conductor is thick, the wiring may be difficult when the wiring path includes a narrow path.

An object of the present application is to provide a cable in which the height of the cable itself can reduced and that can be routed even when the wiring path includes a narrow path.

The cable according to the embodiment includes a plurality of first cables provided in parallel each having a core wire made of conductive metal and an insulation sheath covering an outer circumference of the core wire, wherein the respective core wires exposed from the respective insulation sheaths of the plurality of first cables are connected to a bus bar.

It is preferable that the bus bar have a bolt insertion hole.

The cable according to another embodiment includes a plurality of first cables provided in parallel each having a core wire made of conductive metal and an insulation sheath covering an outer circumference of the core wire, wherein the respective core wires exposed from the respective insulation sheaths of the plurality of first cables are joined to each other by welding.

It is preferable that a flat terminal having a bolt insertion hole be connected to a joint portion in which the respective core wires exposed from the respective insulation sheaths of the plurality of first cables are joined to each other.

It is preferable that a core wire exposed from an insulation sheath of a second cable having a higher allowable voltage than the first cable be connected to the joint portion in which the respective core wires exposed from the respective insulation sheaths of the plurality of first cables are joined to each other.

It is preferable that the first cable preferably have an allowable voltage of less than 12 V.

According to the above configuration, it is possible to provide a cable in which the height of the cable itself is reduced, and that can be routed even when the wiring path includes a narrow path.

### BRIEF DESCRIPTION OF THE DRAWINGS

FIG. 1 is a perspective view illustrating an example of a cable according to the first embodiment of the present application;

FIG. 2 is a perspective view illustrating an example of a cable according to the second embodiment of the present application;

FIG. 3 is a perspective view illustrating an example of a cable according to the third embodiment of the present application; and

FIG. 4 is a perspective view illustrating an example of a cable according to the fourth embodiment of the present application.

### DETAILED DESCRIPTION

Hereinafter, the cable according to the embodiment of the present application will be described in detail with reference to the drawings.

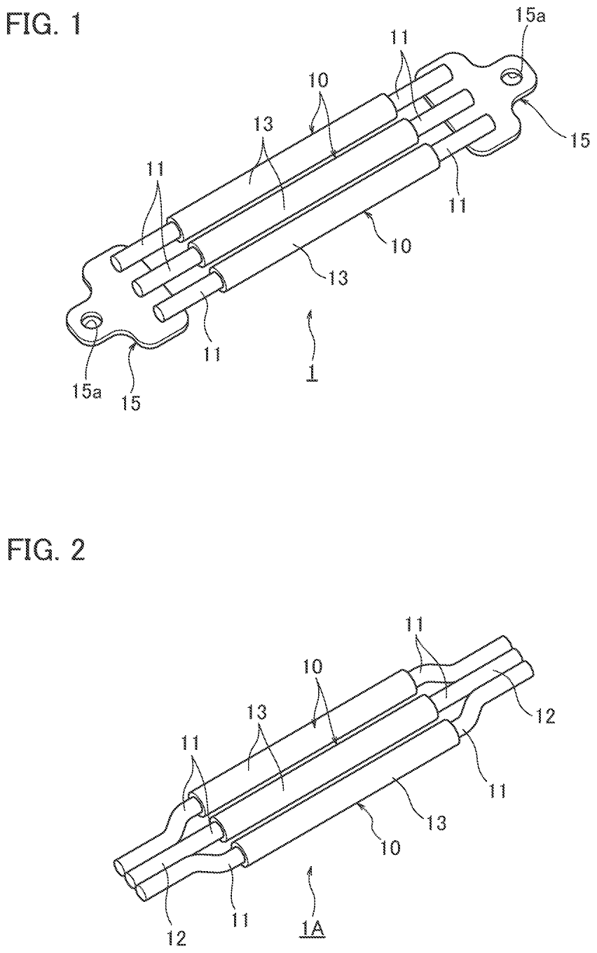

FIG. 1 is a perspective view illustrating an example of a cable according to the first embodiment of the present application.

As illustrated in FIG. 1, the cable 1 includes three small-diameter low-voltage cables (first cables) 10 provided in parallel each having a core wire 11 made of conductive metal and an insulation sheath 13 covering the outer circumference of the core wire 11 and having an allowable voltage (rated voltage) of less than 12 V.

The core wire 11 is made of copper, a copper alloy, aluminum, or an aluminum alloy, and is made by twisting a plurality of strands having a circular cross section.

The core wires 11 exposed from each of the both ends of the respective insulation sheaths 13 of the three low-voltage cables 10 are connected to a bus bar 15 by ultrasonic welding or the like. The core wires 11 of the both terminals of the three low-voltage cables 10 are electrically connected to each other via the pair of bus bars 15 and 15. As a result, a large current equivalent to the current value of a high-voltage cable (corresponding to a high-voltage cable 20 having an allowable voltage of 12 V or more indicated by reference numeral 20 in FIG. 4) as a second cable having an allowable voltage (rated voltage) of 12 V or more flows in the cable 1. The pair of bus bars 15 each has a bolt insertion hole 15a.

As described above, according to the cable 1 of the first embodiment, the core wires 11 of each of the both terminals of the three low-voltage cables 10 are electrically connected to each other via the pair of bus bars 15 and 15, so that as a whole, a large current equivalent to the current value of the high-voltage cable 20 with a large diameter and an allowable voltage of 12 V or more illustrated in FIG. 4 can flow.

The core wires 11 of each of the both terminals of the three low-voltage cables 10 are electrically connected to each other via the pair of bus bars 15 and 15, so that the cable itself can have a reduced height because the cables 10 are made to be flatter when connected to the bus bar 15 rather than when electrically connected in one place as it is.

Furthermore, since the cable diameter per cable can be reduced by subdividing the cable with the three low-voltage cables 10, the cable 1 can be routed in a narrow space under the floor of the vehicle such as an electric car and a hybrid car. That is, the height of the cable itself can be reduced, and even when the wiring path includes a narrow path, the cable can be routed.

FIG. 2 is a perspective view illustrating an example of a cable according to the second embodiment of the present application.

A cable 1A of the second embodiment is different from that of the first embodiment in that the core wires 11 exposed from each of the both ends of each insulation sheath 13 of the three low-voltage cables (first cables) 10 are joined by welding to form a joint portion 12. Since other configurations are similar to those of the first embodiment, the same components are denoted by the same reference numerals, and a detailed description thereof will be omitted.

In the cable 1A of the second embodiment, the core wires 11 exposed from each of the both ends of the respective insulation sheaths 13 of the three low-voltage cables 10 are joined by welding to form a joint portion 12, so that it has the same action and effect as the first embodiment.

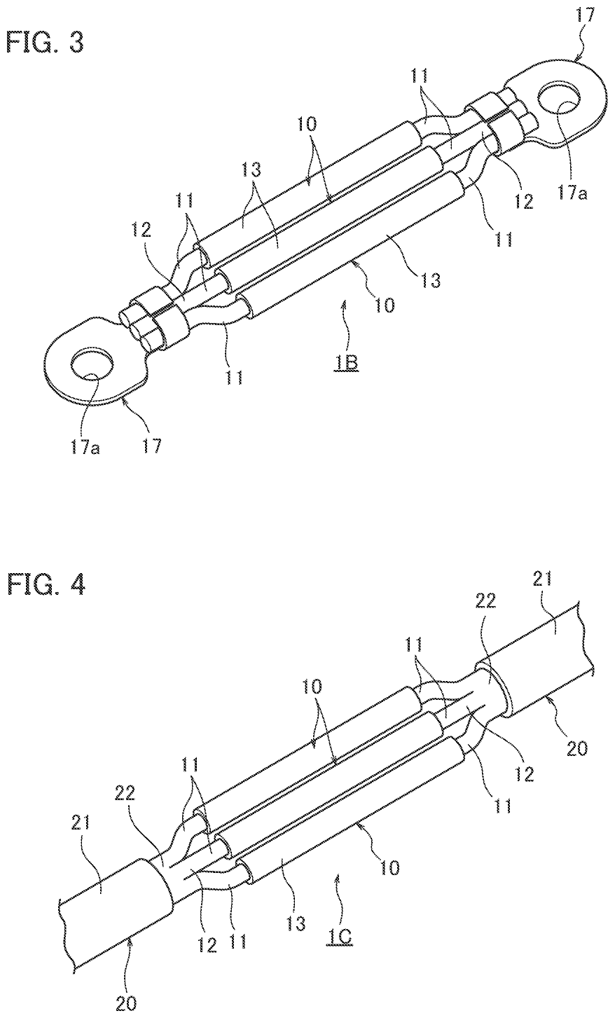

FIG. 3 is a perspective view illustrating an example of a cable according to a third embodiment of the present application.

A cable 1B of the third embodiment is different from that of the second embodiment in that a flat terminal 17 having a bolt insertion hole 17a is crimped and connected to the joint portion 12 in which the core wires 11 exposed from each of the both ends of the respective insulation sheaths 13 of the three low-voltage cables (first cables) 10 are joined to each other. Since other configurations are similar to those of the second embodiment, the same components are denoted by the same reference numerals, and a detailed description thereof will be omitted.

In the cable 1B of the third embodiment, the flat terminal 17 having the bolt insertion hole 17a is crimped and connected to the joint portion 12 in which the core wires 11 exposed from each of the both ends of the respective insulation sheaths 13 of the three low-voltage cables 10 are joined to each other, so that it has the same action and effect as the first embodiment.

FIG. 4 is a perspective view illustrating an example of a cable according to a fourth embodiment of the present application.

A cable 1C of the fourth embodiment is different from that of the second embodiment in that a core wire 22 exposed from the end of an insulation sheath 21 of the high-voltage cable 20 is connected to the joint portion 12 in which the core wires 11 exposed from each of the both ends of the respective insulation sheaths 13 of the three low-voltage cables (first cables) 10 are joined to each other. Since other configurations are similar to those of the second embodiment, the same components are denoted by the same reference numerals, and a detailed description thereof will be omitted.

In the cable 1C of the fourth embodiment, the core wire 22 exposed from the end of the insulation sheath 21 of the high-voltage cable (second cable) 20 having an allowable voltage (rated voltage) of 12 V or more is connected to the joint portion 12 in which the core wires 11 exposed from each of the both ends of the respective insulation sheaths 13 of the three low-voltage cables 10 are joined to each other by welding. As a result, the same actions and effects as those of the first embodiment are obtained. Specifically, it is effective when the cable 1C is routed in a narrow space under the floor of a vehicle such as an electric car or a hybrid car.

Next, a comparative example will be described. In vehicles such as an electric car and a hybrid car, high-pressure wire harnesses are used for electrical connections between electric components such as a battery, an inverter, and a motor.

Generally, as the wire harness, a circuit conductor and a wire harness itself having a round shape are used. When a round wire harness is used, since the high-voltage wire harness is thick, it may be difficult to route the cable when the wiring path includes a narrow path (narrow space).

The cable according to the comparative example includes a high-voltage cable in which a plurality of disposed conductors (core wires) is collectively sheathed with an insulator.

However, in the high-voltage cable according to the comparative example, since the conductor is thick, it may be difficult to route the cable when the wiring path includes a narrow path.

Although the present embodiments are described above, the present application is not limited to the embodiments, and various modifications can be made within the scope of the gist of the present embodiments.

That is, according to each embodiment three low-voltage cables with an allowable voltage of less than 12 V are connected in parallel to form a cable. Two or four low-voltage cables may be connected in parallel without a gap to form a cable.

Also, according to each embodiment, the respective core wires exposed from each of the both terminals of the respective insulation sheaths of the low-voltage cables are electrically connected to each other. The core wires may be exposed from the middle of the respective insulation sheaths of the low-voltage cables and may be electrically connected to each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cable comprising:
a plurality of first cables provided in parallel each having a core wire made of conductive metal and an insulation sheath covering an outer circumference of the core wire, wherein
the respective core wires exposed from the respective insulation sheaths of the plurality of first cables are connected to a bus bar.

2. The cable according to claim 1, wherein the bus bar has a bolt insertion hole.

3. A cable comprising:
a plurality of first cables provided in parallel each having a core wire made of conductive metal and an insulation sheath covering an outer circumference of the core wire, wherein
the respective core wires exposed from the respective insulation sheaths of the plurality of first cables are joined to each other by welding.

4. The cable according to claim 3, wherein a flat terminal having a bolt insertion hole is connected to a joint portion in which the respective core wires exposed from the respective insulation sheaths of the plurality of first cables are joined to each other.

5. The cable according to claim 3, wherein a core wire exposed from an insulation sheath of a second cable having a higher allowable voltage than the first cable is connected to the joint portion in which the respective core wires exposed from the respective insulation sheaths of the plurality of first cables are joined to each other.

6. The cable according to claim 5, wherein the first cable has an allowable voltage of less than 12 V.
